(19) United States
(12) Patent Application Publication
(10) Pub. No.: US 2009/0212169 A1
(43) Pub. Date: Aug. 27, 2009

(54) Cord retention system for clothes pressing devices

(76) Inventor: Betty Jane Craiglow, Fayetteville, AR (US)

Correspondence Address: Betty Jane Craiglow, 770 N. Raincrow Road, Fayetteville, AR, 72704-7880, US

(21) Appl. No.: 12/072,432

(22) Filed: Feb. 26, 2008

(51) Int. Cl. F16L 3/00; D06F 75/00; D06F 81/00

(52) U.S. Cl. 248/51; 38/75; 38/104

(57) ABSTRACT

A device having a tangible dual component reflecting control of an iron cord dilemma. An upper area reserves an opening accommodating said iron cord to facilitate a second addition integrating metal screws and wing nuts for substantial strength.

The present invention is a system for keeping electric cord 3 in definable areas when ironing 4 or pressing clothes or other fabric 5 using an electric iron 6 the system contemplates an electric iron 6 ironing board 7 of variable yet generally accepted industry sizes and a cord holding device 8 within which the cord 9 is permitted only limited travel at the behest of the operator.

The first preferred embodiment 10 is substantially showin in the drawings 11. In this first preferred embodiment 10 there are the two components 12 that interface 13 which are designed 14 to adjustably articulate with one another and ultimately fit snugly around an ironing board 7. The top component 12 has an addition predefined area 15 through which the which the electric cord 3 is initally placed therefore defining 16 the limit 17 within which the coard 7 may travel during the ironing effort 18. The electric cord 3 is thus retainer 19 in a reasonably stationary 20 position on top of the ironing board 7 yet the cord 9 can travel for and aft 21 with variable ease. It is the side-to-side 22 movement that is appreciably curtailed 22 through the use of this cord 24 retention system with the underlying goal 25 to keep the electric cord 3 in control 26 by the operator 27. One typical problem associated with conventional ironing 28 using an electric 28 using an electric 6 iron is that the cord 9 falls off the top of the ironing board 7 sweeps from side-to side 22 and tugs-and-puffs 29 the fabric 15 already pressed. This inability to control 26 the electric cord 3 therefore frustrates the ironing effort 18 using this system 30 the user can easily maintain control 26 of the ironing board 7, the electric cord 3, and the garment or fabric 5 that is the subject 32 of the ironing 4.

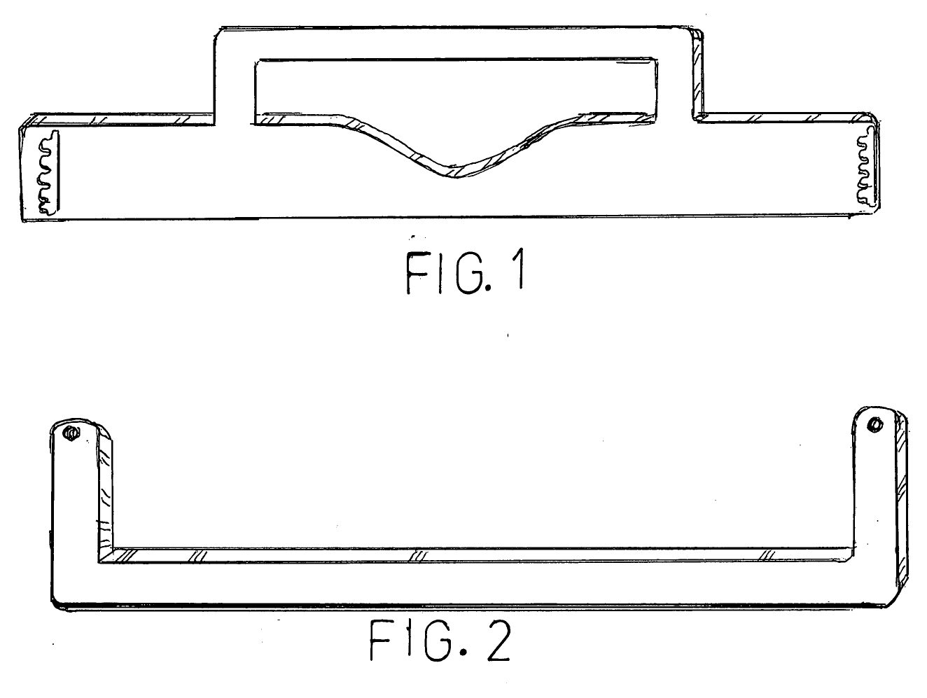

FIG. 1 The upper elongated component shows a handle type apparatus with a lower center curve assisting an ironing cord onto an electric socket. Two rows of five vertical notches being in a lest-to-right position requires a screw to integrate into one of the five notches.

FIG. 2 the second component being an elongated U shape is designated to the underside of said ironing board attached by already predetermined notches on FIG. 1 and accommodating wing nuts tighten to said screws for adjusting the area between upper and lower units loosening wing nuts without totally releasing both units are able to adjust the area between said FIG. 1 and FIG. 2 to settle as one unit. (wing nuts are not shown in the drawing.

1. I claim an electric cord restraing and retention system comprising:
an ironing board having a top surface and a bottom surface;
an iron attached to an electrical cord;
an electric cord retention device having a primary elongated frame component further comprising a first end and a second end, between which a cord retention opening is generally proscribed.
said electric retention device also having a secondary elongated frame component further comprising a first coupling end and a second coupling end, wherein said first coupling end adjustably articulates with the first end of the primary elonged frame component, and where in the second coupling end adjustably articulates with the second frame component, while situated on the ironing board top surface, adjustably articulates with the secondary elongated frame component, while situated on the ironing board bottom surface, it forms a unitary device which snugly surrounds said ironing board.
